(19) United States
(12) Patent Application Publication
(10) Pub. No.: US 2006/0165253 A1
(43) Pub. Date: Jul. 27, 2006

(54) Drum paper of loudspeaker covered with metallic layer

(76) Inventor: Hiroshi Ohara, Tao-Yuan Hsien (TW)

Correspondence Address: BIRCH STEWART KOLASCH & BIRCH, PO BOX 747, FALLS CHURCH, VA, 22040-0747, US

(21) Appl. No.: 11/038,411

(22) Filed: Jan. 21, 2005

(51) Int. Cl. H04R 11/02

(52) U.S. Cl. 381/427; 381/423

(57) ABSTRACT

Disclosed is a drum paper of loudspeaker covered with metallic layer. The drum paper is comprised of a conic base layer made by non-woven fabric or woven fiber, and a metal-covered layer coated on the base layer. The drum paper is provided with an outer circumference extended outwardly to form a suspension rim. Therefore, the drum paper of the present invention is offered with a preferred strength in its thickness direction to present a specific output voice quality with metallic atmosphere and vision effect.

### BACKGROUND OF THE INVENTION

1. Field of the Invention

The present invention relates to a drum paper covered with metallic layer, which is exclusively applied to a loudspeaker.

2. The Prior Arts

A typical dynamic loudspeaker is usually comprised of a power system, a drum paper, and a suspension system. The power system further comprises a magnet, electrode piece, upper iron, gap, and voice coil. The drum paper, which is substantially a diaphragm for moving air, is usually a tapered or semi-spherical voice cone. And, the suspension system is constructed with a damper and a suspension rim for guiding the diaphragm to vibrate in a specified direction. The power system, the drum paper, and the suspension system are all fitted in an iron frame, in which a terminal is provided for setting a power supply to drive the loudspeaker; a conductive cord is applied to connect the terminal to a voice coil; and the terminal is also connected with the power supply such that an electromagnetic field will be generated when a current flows in the voice coil through the terminal and conductive cord. Since the electromagnetic field is perpendicular to the magnetic field of a permanent magnet of the loudspeaker, therefore, a dynamic coil placed in a gap (the clearance between the voice coil and the permanent magnet) is moved to generate a mechanical force. The mechanical force produced by such a movement would cause the diaphragm attached on the voice coil to vibrate up and down such that air is subsequently moved to vibrate and generate audio frequency to achieve the goal of transmutation between electric energy and audio energy. For making drum paper of common loudspeakers, paper, foam rubber, cloths, rubber, or metal material is singly adopted, and for matching with different voice ranges and tones, the control on rigidity, thickness, and strength of a single material is necessary for obtaining the internal loss and vibration pattern of a drum paper and accordingly the required output tones.

### SUMMARY OF THE INVENTION

The primary object of the present invention is to delete the defects of the drum paper of a conventional loudspeaker, which is made by a single material. Most of the drum papers of conventional loudspeakers, except those made in woven cloths, are not strong enough in thickness direction and may be impaired easily in manufacture process or in use. Moreover, with the exception of metal material, the drum papers made of other materials are weak in heat dissipation, so that they cannot be applied to the loudspeakers of high output power.

For improvements, a technical measure of the present invention is to lay a metal-covered layer on a base layer formed with non-woven fabric or woven fiber to become the main structure of a drum paper. In the drum paper, the outer circumference thereof is extended outwardly to form a suspension rim and the central portion thereof is formed of a central hole for assembling a voice coil.

Yet, another technical measure of the present invention is to use plating, coating, or attaching a metal material to bind a metal-covered layer onto a conic base layer made of non-woven or woven cloth.

The drum paper of loudspeaker covered with metallic layer is found capable of making use with following effects: (1) Since the drum paper having a metal-covered layer is provided with a base layer formed in a conic structure built by non-woven or woven cloths, hence, a preferred strength in the thickness direction is obtainable. (2) Because a metallic layer is laid on the surface of drum paper, an output voice quality with metallic interest is obtainable. (3) By means of the metallic layer, a vision effect of metal material can be felt.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a sectional view showing a drum paper of loudspeaker covered with metallic layer of the present invention; and

FIG. 2 is an exploded view of the combination relationship between the drum paper and an iron frame of loudspeaker of the present invention.

### DETAILED DESCRIPTION OF THE PREFERRED EMBODIMENT

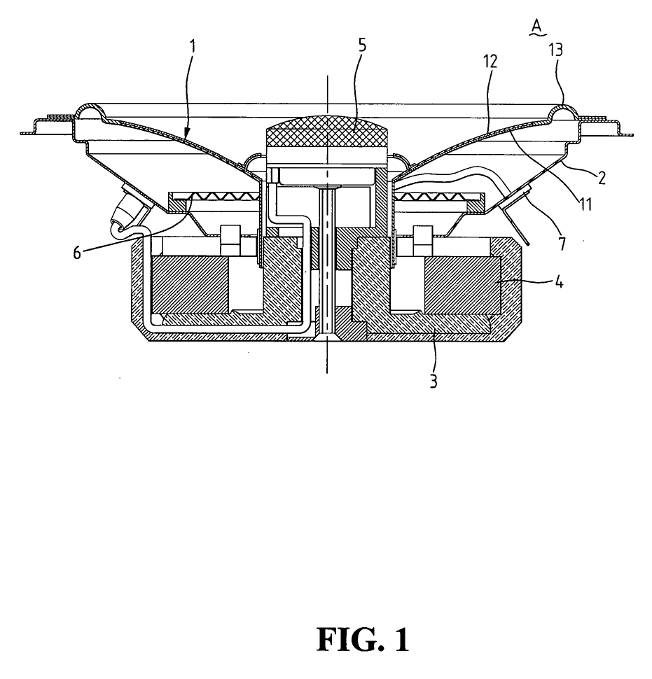

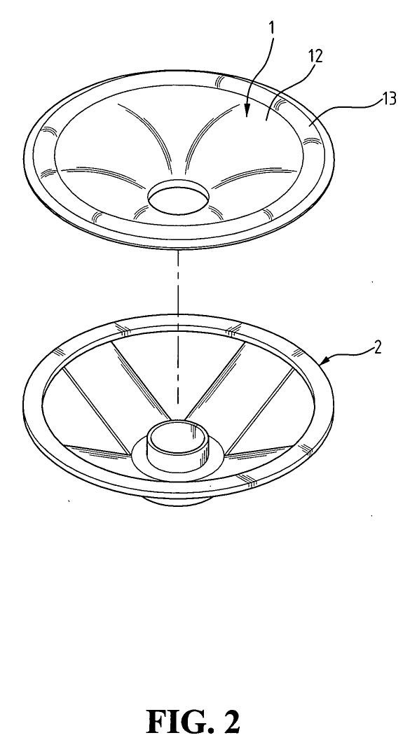

As shown in FIGS. 1 and 2, a drum paper 1 of the present invention is an element assembled in a loudspeaker (A), which is provided with a conic iron frame 2. In the iron frame 2, an upper iron 3 and a magnet 4 are arranged at a bottom end thereof; a damper 6, a voice coil 5 and the drum paper 1 are disposed at an upper center portion thereof, in which the voice coil 5 is fixed centrally at the damper 6 and also a central hole of the drum paper 1; and a suspension rim 13 at the most outer side of the drum paper 1 is fixed at an inner rim of the iron frame 2.

In order to provide a power source for operating a loudspeaker, a terminal 7 is arranged at the iron frame 2 of the loudspeaker (A). The terminal 7, which is connected with the voice coil 5 by means of a conductive cord, is connected to the power source, too. When a current flows through the voice coil 5 via the terminal 7 and a conductive cord, an electromagnetic field is created in a direction perpendicular to the magnetic field of a permanent magnet 4 of the loudspeaker such that a dynamic coil placed between the voice coil 5 and the magnet 4 is moved to generate a mechanical force to thereby result in an up-and-down vibration of the drum paper 1 attached on the voice coil 5. Hence, the air surrounding the loudspeaker is in turn vibrated accordingly to transmit audio energy outwardly to realize the goal of energy transmutation from electric power into audio power.

The drum paper 1 of the present invention is a conic body having a double-layer structure, in which one layer is a base layer 11; the other is a metal-covered layer 12. The base layer 11 is a woven facial structure made by non-woven fabric or high molecular fiber, while the metal-covered layer 12 is a layer of metallic material formed on the base layer 11 by means of plating, coating, or attaching. Before forming the base layer 11 and the metal-covered layer 12 into a conic body, both layers are pre-bound together to become a compound facial material in a plane pattern, which is then pressed and heated into a conic body, and an annular suspension rim 13 is attached to the outer circumference of the conic body. The annular suspension rim 13 is usually made of an elastic material, such as rubber, so that an effect of suspension and elastic vibration of the drum paper could be obtained after the suspension rim is attached at the inner edge of the iron frame 2.

Since the aforementioned drum paper structure of the present invention is a compound structure formed by binding a metal-covered layer with non-woven fabric or woven fiber, therefore, the drum paper is provided with a better rigidity, a more suitable thickness, and a more excellent strength that facilitate an easier control of the inner loss and vibration pattern thereof when vibrating. Moreover, as the drum paper of the present invention is built in a compound structure, it is characterized in the feature of a woven cloth as well as a metal. Besides, the metal-covered layer 12 may shed a specific vision feeling and voice quality.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A drum paper of loudspeaker covered with metallic layer, being a conic body bound with a suspension rim at an outer circumference thereof, in which the conic body is comprised of a base layer and a metal-covered layer laid on the base layer.

2. The drum paper as claimed in claim 1, wherein the base layer is a woven structure constituted with non-woven fabric or high molecular fiber or fiber of other materials; and the metal-covered layer is a metallic layer formed by plating, coating, or attaching on the base layer.
